(19) United States
(12) Patent Application Publication
(10) Pub. No.: US 2006/0077179 A1
(43) Pub. Date: Apr. 13, 2006

(54) Keyboard having automatic adjusting key intervals and a method thereof

(75) Inventors: Ya-Hsun Hsu, Taipei (TW); Vam Chang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 10/960,041

(22) Filed: Oct. 8, 2004

(51) Int. Cl. G09G 5/00

(52) U.S. Cl. 345/168; 345/173

(57) ABSTRACT

A keyboard with automatic adjusting key intervals can adjust the key interval values and the key frame edge values of a keyboard according to the detected contour scope of a user's hands. The adjusted keyboard is displayed on a touch screen so that the user can perform keyboard operation more smoothly on the keyboard that matches the size of his/her hands.

### FIELD OF THE INVENTION

The present invention relates to a keyboard and particularly to a touch screen keyboard that has automatic adjusting key intervals.

### BACKGROUND OF THE INVENTION

With the arrival of the information age, data processing equipment has been woven in people's life and has brought great conveniences to people. The data processing equipment generally includes output devices and input devices. The output devices include screens, speakers, printers and the like. The input devices include a keyboard, a mouse, a hand writing panel and the like. The keyboard is the most commonly used basic input device. The keyboard generally adopts a mechanical design. A plastic shell marked by a symbol covers each key. There are an elastic element and a sensor beneath the shell. When a user presses the key, the sensor detects the compression and transmits a signal to the data processing equipment through a data bus to process data input operation. The mechanical design requires a selected interval for each key. The size of the key on the present keyboards does not have much difference. When children (or users with small hands) want to learn input skills, they often feel awkward and cannot operate at will, because their hands are too small.

Moreover, a notebook computer keyboard generally is smaller than a desktop computer keyboard. It also adopts a mechanical design. Users have to adapt to the size of the keyboard. Therefore to develop a keyboard with adjustable key intervals to suit the size of user's hands to improve operation convenience is one of the issues pending to be resolved in the industry.

### SUMMARY OF THE INVENTION

In view of the aforesaid disadvantages and pending problems, the present invention aims to provide a keyboard with automatic adjusting key intervals that allows the intervals of the keys on the keyboard to be adjusted according to the detected size of user's hands and enables the user to select a suitable keyboard according to the size of his/her hands, to improve keyboard operation.

In order to achieve the foregoing object, the keyboard with automatic adjusting key intervals according to the invention includes a detection module, an adjustment module and a display module.

The detection module aims to measure the size of a user's hands by optical sensing or pressure sensing to get the coordinate values of X and Y axes of the outmost boundary of user's hands to obtain the contour scope of the user's hands.

The adjustment module is connected to the detection module to adjust display values according to the obtained contour scope of user's hands. The display values include key interval values and key frame edge values. The adjusted keyboard is displayed on the display module to enable the user to enter input data.

The display module determines the keyboard display type according to the adjusted display values and displays the keyboard. This may be a touch screen.

The invention further includes an actuation module and a storing module. The actuation module activates the detection module to measure user's hands, either the first time or not. The storing module stores a plurality of keyboards of different display values to allow the adjustment module to access or store the keyboards that have been adjusted according to the display values.

In addition, the invention provides a method for automatic adjusting the key intervals. It includes the steps of: first, in a detection mode, a user places his/her hands on a touch screen to be measured; get the coordinate values of X and Y axes of the outmost boundary of user's hands to obtain the contour scope of the user's hands; adjust display values according to the obtained contour scope of user's hands; and determine the keyboard display type according to the adjusted display values and display on the touch screen.

The keyboard with automatic adjusting key intervals and the method thereof enable a user to use a keyboard of a suitable dimension according to the size of his/her hands to improve keyboard operation.

The foregoing, as well as additional objects, features and advantages of the invention will be more readily apparent from the following detailed description, which proceeds with reference to the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system block diagram of automatic adjusting keyboard intervals of the invention; and

FIG. 2 is a process flow chart of the method for automatic adjusting keyboard intervals of the invention.

### DESCRIPTION OF THE PREFERRED EMBODIMENTS

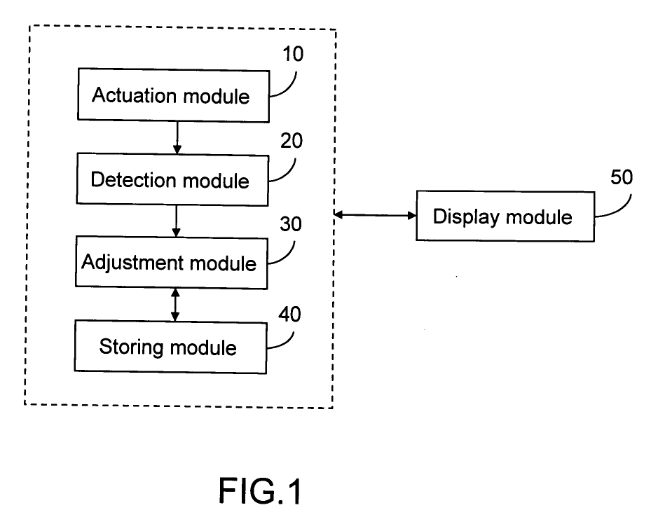

Refer to FIG. 1 for a system block diagram of the keyboard with automatic adjusting key intervals of the invention. It includes an actuation module 10, a detection module 20, an adjustment module 30, a storing module 40 and a display module 50.

The actuation module 10 is activated by a user to generate an actuation signal to actuate the detection module 20. It includes a button switch or a key on the display module 50 which is a touch screen.

The detection module 20 is connected to the actuation module 10 to receive the actuation signal to activate a detection mode. In the detection mode, the user places the hands on the display module 50 to process measuring operation and obtain the coordinate values of X and Y axes of the outmost boundary of the user's hands to get its contour scope.

The measuring method may be an optical sensing or a pressure sensing. The optical sensing may adopt infrared light scanning or LED (light emitting diode) optical sensing. This approach is to place light sources and photo receivers around the frame of the display module 50. The hands block the optical signals so that the coordinate values of X and Y axes of the outmost boundary of user's hands are obtained on the display module 50 to form its contour scope.

The pressure sensing approach is to directly place the hands onto the display module 50 and compress to get the coordinate values of X and Y axes of the outmost boundaries of user's hands on the display module 50 to obtain its contour scope.

The adjustment module 30 takes the contour scope of user's hands from the detection module 20 as the maximum usable scope boundary values of the keyboard layout to adjust the display values. The adjusted display values are rearranged and composed to become the boundary values of the upper, lower, left and right boundary values of the keyboard that do not exceed the maximum usable scope boundary values. The display values include key intervals and key frame edge values. The keyboard adjustment method may adopt a proportional shrinking approach that uses the maximum usable scope boundary values as a boundary line to shrink the keyboard proportionally, or access a keyboard with a preset value in the storing module 40 that is the closest to the maximum usable scope boundary values.

If the user is not satisfied with the adjusted keyboard dimension, he/she can activate the detection mode again through the actuation module 10 to redo adjustments of the key intervals and the size of the keys until they are acceptable.

The storing module 40 is connected to the adjustment module 30 to store a plurality of keyboards that have different keyboard intervals and key frame edge dimensions, and allow the adjustment module 30 to access the one that is the closest to the maximum usable scope boundary values. In addition, the storing module 40 also can store the key intervals and key frame edge values measured by the user so that these values may be directly accessed in the next machine start time, to avoid repeated measurement and adjustment during every machine start time.

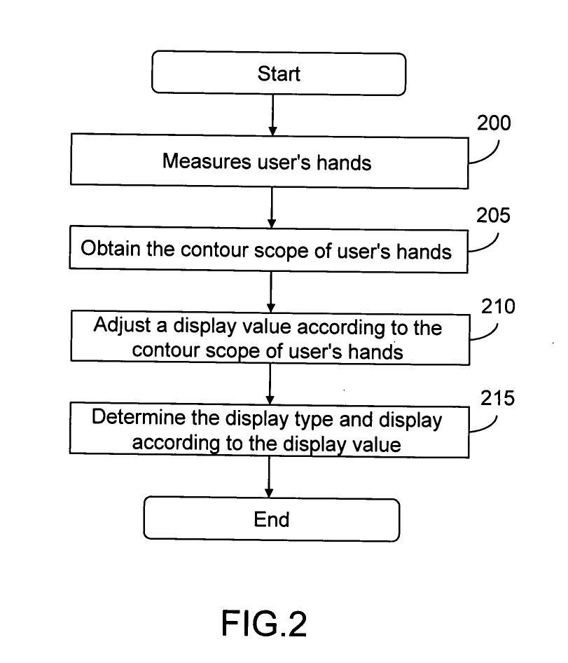

Refer to FIG. 2 for the process flow of the method of the keyboard with automatic adjusting key intervals of the invention. First, in the detection mode, a user places the hands on the display module 50 (step 200); the detection module 20 measures the coordinate values of X and Y axes of the outmost boundary of user's hands and obtains the contour scope of the user's hands (step 205); the adjustment module 30 adjusts the key interval values and key frame edge values according to the contour scope of user's hands that serves as the maximum usable scope boundary value (step 210); finally display the adjusted keyboard on the display module (step 215).

By means of the keyboard with automatic adjusting key intervals and method set forth above, a user can automatically adjust the key intervals according to the size of his/her hands to meet his/her requirements to improve keyboard operation. In addition, because the keyboard is on the touch screen, the problem of clearing the dusts and dirt accumulated in the ditches between keys of the mechanical keyboard may be prevented. The flat touch screen also is easier to clean.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A keyboard having automatic adjusting key intervals allowing a keyboard display type to be adjusted according to a detected size of a user's hands, the keyboard comprising:
a detection module for measuring and obtaining a contour scope of the user's hands;
an adjustment module for adjusting a display value of the keyboard according to the contour scope; and
a display module to determine the keyboard display type according to the display value and display the keyboard.

2. The keyboard of claim 1, wherein the contour scope is the coordinate values of X and Y axes of the outmost boundary of the user's hands.

3. The keyboard of claim 1, wherein the detection module includes an optical sensing circuit to obtain the contour scope of the user's hands.

4. The keyboard of claim 1, wherein the detection module includes a pressure sensing circuit to obtain the contour scope of the user's hands.

5. The keyboard of claim 1, wherein the display value is a key interval value.

6. The keyboard of claim 1, wherein the display value is a key frame edge value.

7. The keyboard of claim 1 further including an actuation module to activate the detection module.

8. The keyboard of claim 1 further including a storing module for storing a plurality of keyboards that have varying key interval values and key frame edge values.

9. The keyboard of claim 8, wherein the storing module further stores the key interval values and the key frame edge intervals that have been adjusted by the adjustment module.

10. The keyboard of claim 1, wherein the display module is a touch screen.

11. A method for automatically adjusting key intervals to adjust a keyboard display type according to a detected size of a user's hands, the method comprising the steps of:
measuring the user's hands;
obtaining a contour scope of the hands;
adjusting a display value according to the contour scope; and
determining and displaying the display type according to the display value.

12. The method of claim 11, wherein the measuring the user's hands is processed by an optical sensing approach.

13. The method of claim 11, wherein the measuring the user's hands is processed by a pressure sensing approach.

14. The method of claim 11, wherein the contour scope is the coordinate values of X and Y axes of the outmost boundary of the user's hands.

15. The method of claim 11, wherein the display value is a key interval value.

16. The method of claim 11, wherein the display value is a key frame edge value.

17. The method of claim 11, wherein the adjusting a display value is processed according to a proportional shrinking approach.

18. The method of claim 11, wherein the adjusting a display value is processed by accessing a preset value.
